(19) United States
(12) Patent Application Publication
(10) Pub. No.: US 2008/0310437 A1
(43) Pub. Date: Dec. 18, 2008

(54) Method and apparatus for carrying unknown traffic over a resilient packet ring (RPR) without flooding

(75) Inventors: Weiying Cheng, Naperville, IL (US); Chris R. Zettinger, Wheaton, IL (US); Eric L. Chan, Naperville, IL (US); Matthew S. Vrba, Chicago, IL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc., Naperville, IL (US)

(21) Appl. No.: 11/818,760

(22) Filed: Jun. 15, 2007

(51) Int. Cl. H04L 12/28

(52) U.S. Cl. 370/404

(57) ABSTRACT

A method and corresponding apparatus allows unknown packet traffic, such as Ethernet traffic, to be carried on a Resilient Packet Ring (RPR) network without flooding the traffic on the RPR network. Modules in a station of the ring network compare a destination address in a packet traffic signal with known addresses and associate an identifier of a tunnel in the ring network with the packet traffic signal based on the comparison. The modules then associate with the packet traffic signal an identifier of a destination station in the ring network that corresponds to the identifier of the tunnel and forward the packet traffic signal to the destination station via the tunnel. By transmitting the packet traffic via tunnels instead of flooding the RPR network, spatial reuse may be implemented allowing the network to support a higher volume of traffic.

### BACKGROUND OF THE INVENTION

Stations in a Resilient Packet Ring (RPR) network can bridge non-RPR traffic, such as Ethernet traffic, received on a non-RPR port of an RPR station. An RPR station keeps a table that includes addresses of each station on the RPR ring, and may learn addresses using typical leaning techniques. If the station receives a traffic signal with a destination address, or source address, that does not exist in the table, the station sends that traffic over the entire ring, which is known as “flooding the traffic.” Flooding the traffic allows the station to deliver the traffic to its destination and to make sure bridges and switches attached to the RPR stations can learn the address and record it in their tables. The drawback of flooding the traffic on the RPR ring network is that it consumes network resources that otherwise would not have been used if the station had already learned to which port to send the packet, therefore, limiting reuse of bandwidth in different spans of the RPR ring network (i.e., spatial reuse).

### SUMMARY OF THE INVENTION

According to one example embodiment of the present invention, a station in a ring network includes a comparison module that compares a destination address in a packet traffic signal with known addresses. The known addresses correspond to identifiers of tunnels in the ring network that have been previously associated with the known addresses. The station also includes an association module that associates an identifier of a tunnel in the ring network with the packet traffic signal based on a comparison made by the comparison module. The association module also associates an identifier of a destination station in the ring network with the packet traffic signal. This destination station identifier corresponds to the tunnel identifier that is associated with the traffic packet signal. The station also includes a forwarding module that forwards the packet traffic signal to the destination station via the tunnel.

In another example embodiment, a station in a ring network includes a learning module that learns a correspondence between addresses and identifiers of tunnels in the ring network. The station also includes an association module that associates an identifier of a tunnel in the ring network with an identifier of another station in the ring network. The association is based on a table that has a correspondence between identifiers of tunnels and identifiers of other stations in the ring network.

In yet another example embodiment, a station in a ring network includes a table that has a correspondence between identifiers of tunnels in the ring network and identifiers of other stations in the ring network.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram illustrating a Resilient Packet Ring (RPR) network having four stations.

FIG. 2A-2D are schematic diagrams illustrating learning of addresses and handling of traffic at a station in an RPR ring network.

FIG. 3 is a block diagram illustrating comparison, association, and forwarding modules of a station in an RPR ring network.

FIG. 4A is a block diagram illustrating learning and association modules of a station in an RPR ring network.

FIG. 4B is a flow diagram illustrating learning a correspondence between address and tunnel identifiers, and associating a tunnel identifier with an RPR station identifier.

FIGS. 5A and 5B are flow diagrams illustrating adding information to traffic to be forwarded on a tunnel of the RPR ring network.

FIGS. 6A and 6B are flow diagrams illustrating handling network traffic received at a station in an RPR ring network.

### DETAILED DESCRIPTION OF THE INVENTION

A description of example embodiments of the invention follows.

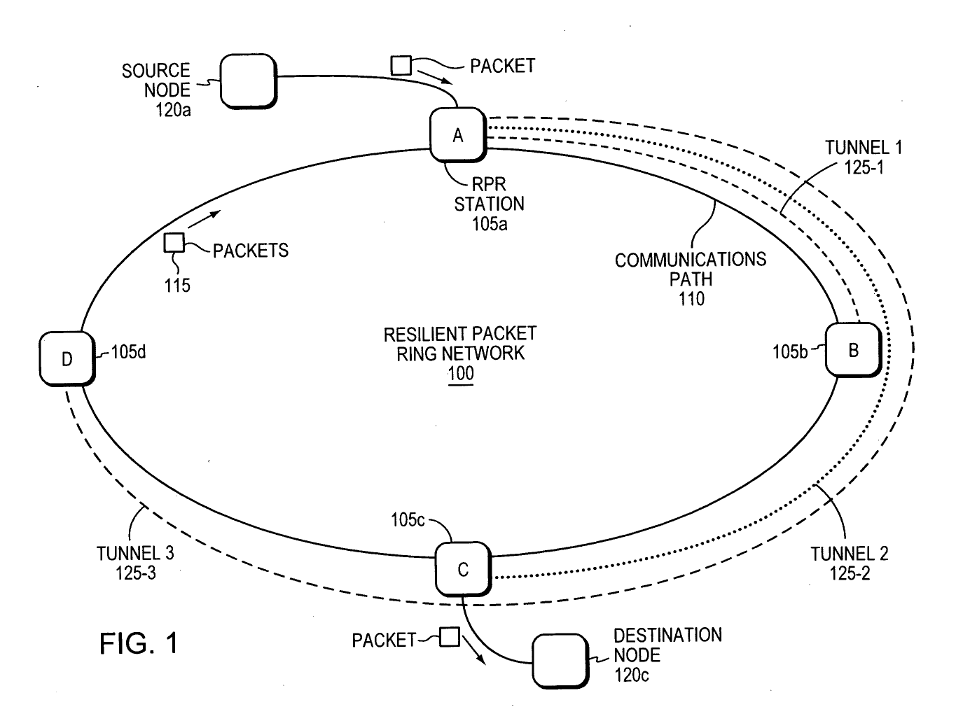

FIG. 1 is a network diagram of a Resilient Packet Ring (RPR) network (“RPR ring”) 100, also referred to herein simply as a “ring.” The ring 100 has four physical switches 105a-d coupled by a communications path 110. In the example, traffic (e.g., packets) 115 travels clockwise around the ring 100, three tunnels 125-1,2,3 are configured by provisioning or signaling, for example, on the ring 100. The tunnels include: Tunnel 1 125-1 for traffic traveling from Station A 105a to Station B 105b, Tunnel 2 125-2 for traffic traveling from Station A 105a to Station C 105c, and Tunnel 3 125-3 for traffic traveling from Station A 105a to Station D 105d. The terms “traffic” and “communications” are synonymous as used herein. The term “traffic” can be packets or frames, which are also synonymous as used herein.

A Resilient Packet Ring (RPR) protocol refers to a ring-based network protocol that supports bridging to other network protocols, such as Ethernet. Today's RPR ring networks use 48-bit source and destination Media Access Control (MAC) addresses in the same format as Ethernet. When Ethernet traffic is bridged onto an RPR ring, an RPR station on the ring encapsulates the Ethernet traffic with an RPR header in an RPR frame. Likewise, when a station removes an RPR frame from the ring, the station removes the RPR header from the RPR frame in the Ethernet traffic.

To transmit a frame from one RPR station to another on the RPR ring, RPR processing in the RPR station encapsulates the frame with an RPR header and adds the newly formed RPR frame to the ring. A station may flood the RPR frame to all other stations on the ring by setting information in the RPR header to indicate that the frame is to be flooded. While the RPR frame traverses the ring, it encounters other RPR stations.

At a given station, the destination address of the RPR header is examined. If the destination address of the frame's RPR header is the same as the station's address and the frame is not indicated as being flooded, then the frame is copied without being forwarded to the next station on the ring. On the other hand, if the destination address of the RPR header is different than the station's address and the frame is not indicated as being flooded, then the frame is forwarded to the next station on the ring. However, if the frame is indicated as being flooded, then the frame is copied before being forwarded to the next station on the ring. To prevent a flooded frame from endlessly traveling around the ring, the station will also examine the source address of the RPR header. If the source address is the same as the station's address, then the frame will be dropped, thus, preventing an infinite loop.

When an RPR station receives a non-flooded RPR frame and recognizes the destination address, it removes the RPR frame completely from the ring, unlike in the case of flooded frames, in which it simply copies the contents of the frame and lets the frame traverse the rest of the ring. When the receiving station removes the RPR frame from the ring, the bandwidth otherwise consumed by the RPR frame is available for use by other RPR stations. This is known as spatial reuse.

A station in an RPR ring network has a table that contains the address of each RPR station in the RPR ring network. If the station receives a traffic signal with a destination address that does not exist in the table, the station floods the traffic on the ring and, therefore, limits reuse of the bandwidth in different spans of the ring network. For example, if a packet is to be sent from a source node 120a to a destination node 120c, current RPR ring network technology receives the packet at RPR Station A 105a on a non-RPR port, and floods the packet on the ring. RPR Station C then copies the packet and sends the packet to destination node 120c via a non-RPR port. Since the packet is flooded on the RPR ring, other RPR stations, such as Station B 105b and Station D 105d, also copy the packet.

An example embodiment of the present method and apparatus allows an RPR station in a ring network to forward a traffic packet with an unknown destination address to another station on the ring network without flooding the traffic on the ring. For a traffic packet that is to be sent from source node 120a to destination node 120c, RPR Station A 105a receives the packet on a non-RPR port from source node 120a and sends the packet to Tunnel 2 125-2 based on a forwarding table (not shown). The packet is then sent to RPR Station C 105c via Tunnel 2 125-2 based on a mapping table (also not shown), without flooding the packet on the ring network. It should be noted that Station B 105b is not involved with traffic between Station A 105a and Station C 105c, and that the packet is not sent to Station D 105d.

According to an embodiment of the present invention, a destination address in a packet traffic signal is compared with known addresses. The known addresses correspond to identifiers of tunnels in the ring network that have been previously associated with the known addresses. An identifier of a tunnel in the ring network is then associated with the packet traffic signal based on the comparison, and an identifier of a destination station in the ring network is associated with the packet traffic signal. This identifier of the destination station corresponds to the identifier of the tunnel associated with the traffic packet signal. The packet traffic signal is then forwarded to the destination station via the tunnel.

The destination address in the packet traffic signal may be a Media Access Control (MAC) address or may be an unknown address. For unknown addresses, a correspondence between the unknown addresses and the identifiers of tunnels may be learned using standard learning techniques. A forwarding table may be provided that has correspondence between the known addresses and the identifiers of tunnels, and an identifier of a tunnel may be determined from the forwarding table based on the destination address. The identifier of the tunnel may be added to the packet traffic signal. A mapping table providing a correspondence between the identifiers of tunnels and identifiers of destination stations in the ring network may provisioned or signaled, and the identifier of the destination station may be determined from the table based on the identifier of the tunnel. The identifier of the destination station may be a Resilient Packet Ring (RPR) MAC address, and may be added to the packet traffic signal.

According to another embodiment, a correspondence between addresses and identifiers of tunnels in the ring network may be learned. An identifier of a tunnel in the ring network may be associated with an identifier of a station in the ring network based on a table having a correspondence between the identifiers of tunnels and identifiers of stations in the ring network. The table may be provisioned and may be updated through signaling techniques.

According to yet another embodiment, a table may be provided that has a correspondence between identifiers of tunnels in the ring network and identifiers of other stations in the ring network. The identifiers of tunnels correspond to multiple logical ports of the station, which are associated with a single ring port of the station.

The tunnels of the example embodiments are used to connect RPR stations in an RPR ring network, may be configured based on the demands of the traffic on the ring network, and may include Virtual Local Area Network (VLAN), Multi Protocol Label Switching (MPLS), or MAC in MAC tunnels. These tunnels can be manually or automatically created and managed. Each tunnel connects two RPR stations and has a unique identifier. For example, a VLAN tunnel uses the VLAN identifier as the identifier, an MPLS tunnel uses the MPLS tunnel label as the identifier, and a MAC in MAC tunnel uses the outer MAC address as the identifier. The MAC addresses of the source and destination RPR stations (RPR-SMAC and RPR-DMAC) are associated with the tunnel identifier in the following triplet: (identifier, RPR-DMAC, RPR-SMAC). The association can be either manually provisioned or automatically signaled using a tunnel control plane. It should be noted that virtual circuits may be implemented within the tunnels.

According to embodiments of the present invention, the tunnels are treated as Layer 2 bridging ports; thus, instead of simply forwarding traffic to an RPR port, the station forwards the traffic to logical tunnel ports based on a forwarding table. The station also keeps a mapping table providing a correspondence between tunnel identifiers and RPR station identifiers. This mapping table may be manually or automatically provisioned, and may be updated using signaling.

An RPR station may apply standard learning techniques to associate traffic having unknown destination addresses with an identifier of a tunnel connecting to the RPR station. Once the traffic is associated with a tunnel identifier, it is no longer necessary to flood the traffic on the RPR ring, since the tunnel is associated with a destination RPR station based on the mapping table. The station may then forward the traffic to the destination RPR station via the tunnel.

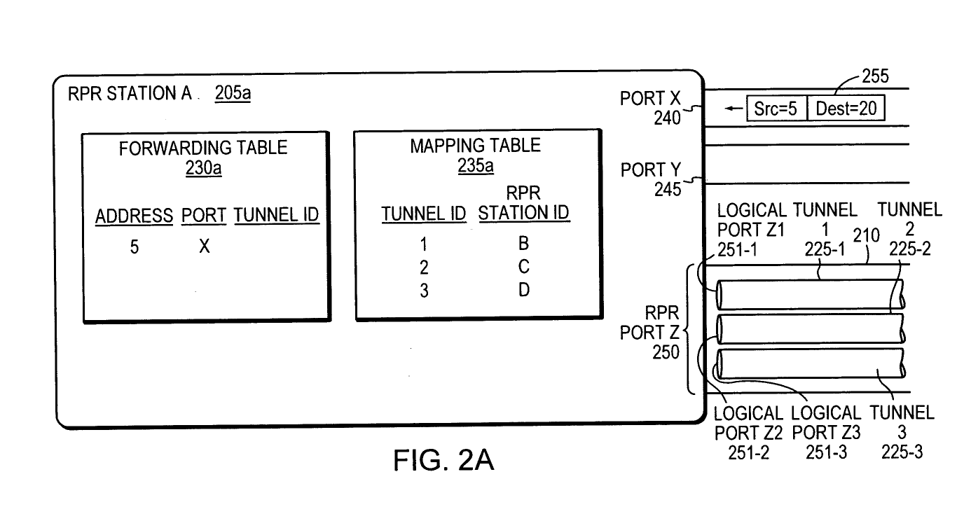

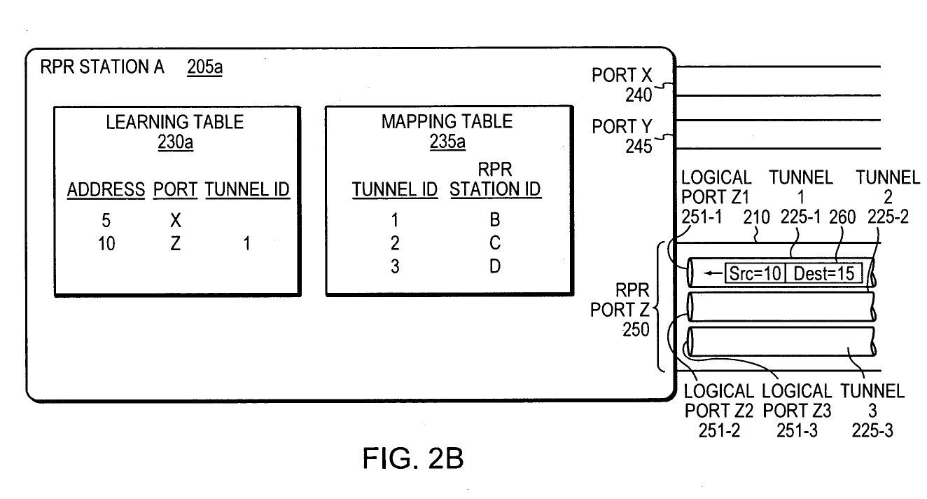

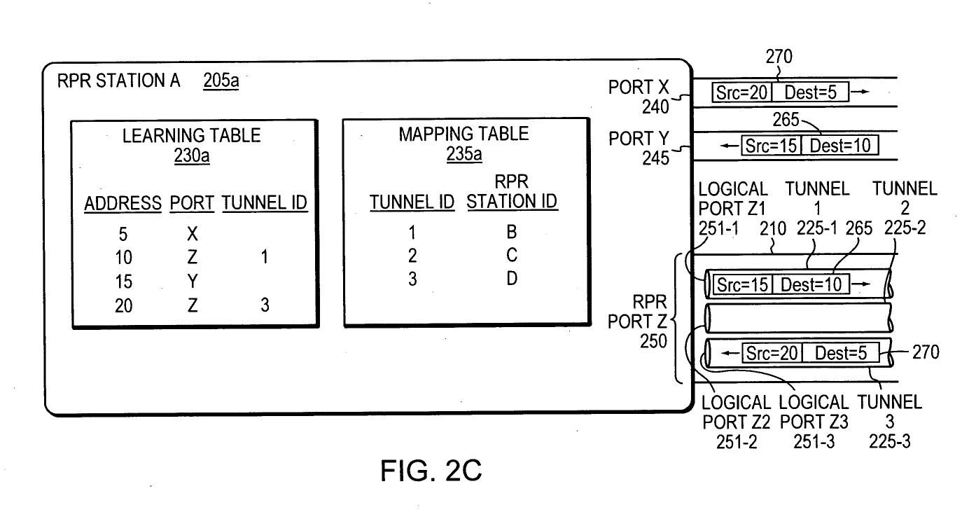

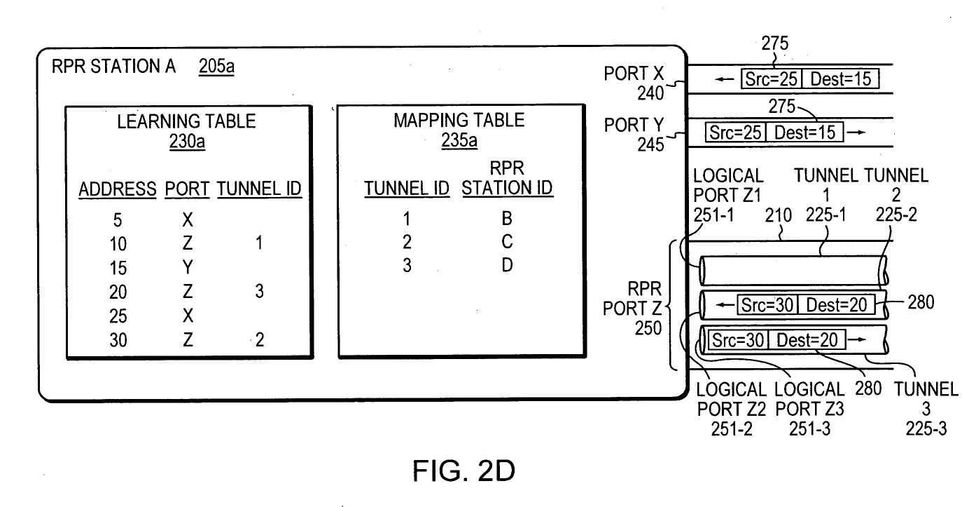

FIGS. 2A-2D are detailed block diagrams illustrating learning of address and handling of traffic at a station 205a in an RPR ring network according to an embodiment of the present invention. In the example embodiment, Station A 205a has three physical ports, Port X 240, Port Y 245, and Port Z 250. Ports X 240 and Y 245 are non-RPR ports, while port Z 250 is an RPR port with access to the RPR ring 210. The station is connected to three tunnels 225-1, 225-2, 225-3 of the ring network, accessed through RPR port Z 250, which is logically divided into three logical ports, Z1 251-1, Z2 251-2, and Z3 251-3. These logical ports 251-1, 251-2, 251-3 correspond to the tunnels 225-1, 225-2, 225-3 connected to Station A 205a.

The RPR station 205a includes a forwarding table 230a used in learning a correspondence between addresses and port identifiers. If a given port identifier corresponds to an RPR port, then the table 230a also keeps track of which tunnel identifier, if any, is to be associated with the address. The RPR station 205a also includes a mapping table 235a that has a correspondence between tunnel identifiers and RPR station identifiers. The mapping table 235a may be manually or automatically provisioned through signaling.

FIG. 2A is a schematic diagram that illustrates a traffic packet 255 arriving at RPR Station A 205a on Port X 240. In this example, the traffic packet 255 has a source address of “5” and a destination address of “20.” Because the traffic packet 255 has been received on Port X 240 with a source address of “5,” the station 205a learns that packets with a destination address of “5” should be forwarded to Port X 240 and adds an entry to the forwarding table 230a that includes the address of “5” and an identifier of Port X 240. In this example, the entry does not include a tunnel identifier since the traffic packet 255 was not received on a logical port (i.e., was not received from a tunnel in the ring network).

FIG. 2B is a schematic diagram that illustrates a traffic packet 260 arriving at Station A 205a on Logical Port Z1 251 -1. The traffic packet 260 has an source address of “10” and a destination address of “15”; thus, the station 205a adds an entry to the forwarding table 230a that includes the address of “10” and an identifier of Port Z 250. Because the traffic packet 260 is received on a logical port (i.e., received from a tunnel in the ring network), the entry includes an identifier of the tunnel from which the packet was received, in this example, the identifier of Tunnel 1 225-1.

FIG. 2C is a schematic diagram that illustrates two traffic packets 265, 270 arriving at Station A 205a: one on Port Y 245 and the other on Logical Port Z3 251-3. The first traffic packet 265 has an source address of “15” and a destination address of “10”; thus, the station 205a adds an entry to the forwarding table 230a that includes the address of “15” and an identifier of Port Y 245. Since the destination address of the first packet 265 (“10”) exists in the forwarding table 230a, the station 205a associates the identifier of Port Z 250 and the identifier of Tunnel 1 225-1 with the traffic packet 265. Since a tunnel identifier has been associated with the packet, the station 205a associates an RPR station identifier with the traffic packet 265 based on the mapping table 235a and the tunnel identifier. In this example, the station 205a associates the identifier of Station B 105a (FIG. 1) with the packet 265 because, according to the mapping table 235a, the identifier of Station B 105a (FIG. 1) corresponds with the identifier of Tunnel 1 225-1. The station 205a then forwards the packet on Tunnel 1 225-1 (via Logical Port Z1 251-1) to Station B 105a (FIG. 1) without flooding the traffic on the ring.

The second traffic packet 270 has an source address of “20” and a destination address of “5”; thus, the station 205a adds an entry to the forwarding table 230a that includes the address of “20,” the identifier of Port Z 250, and an identifier of Tunnel 3 225-3. Since the destination address of the second packet 270 (“5”) exists in the forwarding table 230a, the station 205a associates the identifier of Port X 240 with the traffic packet 270. Since there is no tunnel identifier that has been associated with the packet 270, the station 205a forwards the packet 270 to Port X 240 without reference to the mapping table 235a.

FIG. 2D is a schematic diagram that illustrates two traffic packets 275, 280 arriving at Station A 205a: one on Port X 240 and the other on Logical Port Z2 251-2. The first traffic packet 275 has an source address of “25” and a destination address of “15”; thus, the station 205a adds an entry to the forwarding table 230a that includes the address of “25” and the identifier of Port X 240. Since the destination address of the first packet 275 (“15”) exists in the forwarding table 230a, the station 205a associates the identifier of Port Y 245 with the traffic packet 275. Since there is no tunnel identifier that is associated with the packet 275, the station 205a forwards the packet 270 on port Y 245 without reference to the mapping table 235a.

The second traffic packet 280 has an source address of “30” and a destination address of “20”; thus, the station 205a adds an entry to the forwarding table 230a that includes the address of “30,” the identifier of Port Z 250, and the identifier of Tunnel 2 225-2. Since the destination address of the second packet 270 (“20”) exists in the forwarding table 230a, the station 205a associates the identifier of Port Z 250 and the identifier of Tunnel 3 225-3 with the traffic packet 280. Since a tunnel identifier is associated with the packet 280, the station 205a associates an RPR station identifier with the traffic packet 280 based on the mapping table 235a and the tunnel identifier. In this example, the station 205a associates the identifier of Station D 105d (FIG. 1) with the packet 280 because, according to the mapping table 235a, the identifier of Station D 105d (FIG. 1) corresponds with the identifier of Tunnel 3 225-3. The station 205a then forwards the packet 280 on Tunnel 3 225-3 (via Logical Port Z3 251-3) to Station D 105d (FIG. 1) without flooding the traffic on the ring.

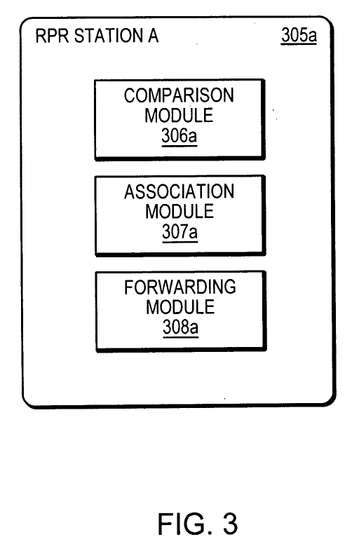

FIG. 3 is a block diagram illustrating comparison, association, and forwarding modules of a station in an RPR ring network, according to an embodiment of the present invention. Station A 305a, for example, includes a comparison module 306a, an association module 307a, and a forwarding module 308a. The comparison module 306a compares a destination address in a packet traffic signal with known addresses that correspond to tunnel identifiers. The association module 307a then associates one of the tunnel identifiers with the packet traffic signal based on the comparison made by the comparison module 306a, and associates an RPR station identifier corresponding to the tunnel identifier with the packet traffic signal. The forwarding module 308a then forwards the packet traffic signal to the identified RPR station via the identified tunnel.

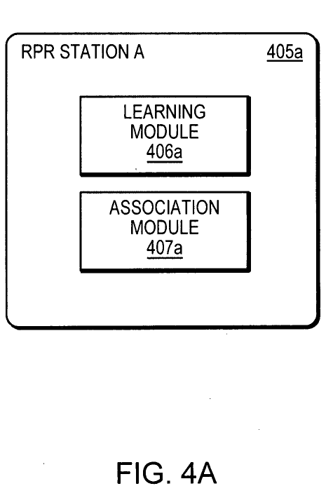

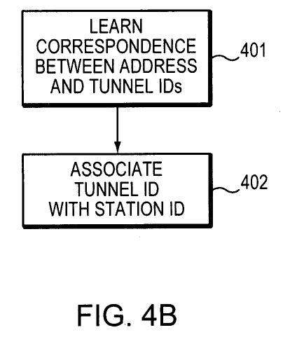

FIG. 4A is a block diagram illustrating learning and association modules of a station in an RPR ring network, according to an embodiment of the present invention. Station A 405a, for example, includes a learning module 406a and an association module 407a. The learning module 406a uses standard learning techniques to learn a correspondence between addresses in packet traffic signals and tunnel identifiers in the RPR ring network. The association module 407a then associates one of the tunnel identifiers with an RPR station identifier based on a table that has a correspondence between tunnel identifiers and RPR station identifiers.

FIG. 4B is a flow diagram illustrating the learning of a correspondence between addresses and tunnel identifiers, and the associating of a tunnel identifier with an RPR station identifier as in the embodiment of FIG. 4A. According to the embodiment, a correspondence is learned between addresses in packet traffic signals and tunnel identifiers of the RPR ring network (401). An RPR station identifier is then associated with one of the tunnel identifiers based on an existing table that has a correspondence between tunnel identifiers and RPR station identifiers (402).

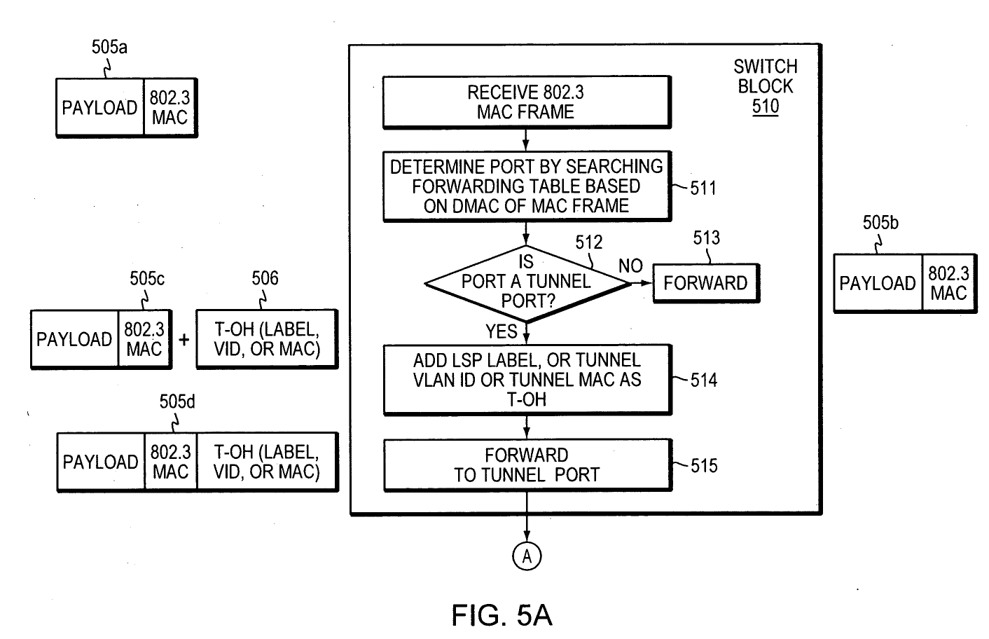

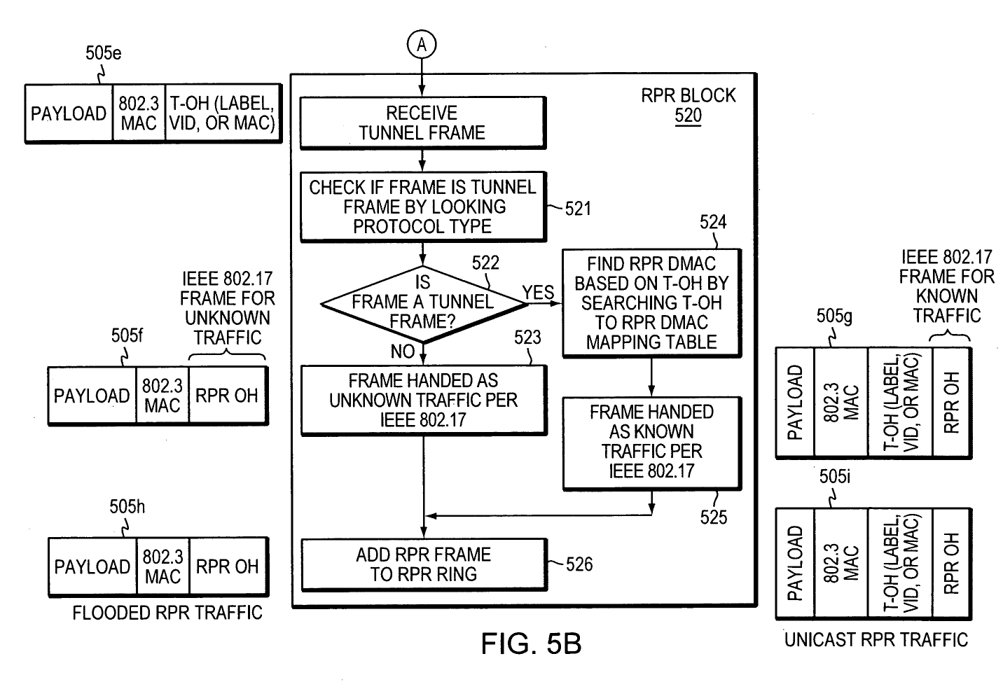

FIGS. 5A and 5B are flow diagrams illustrating adding information to traffic to be forwarded on a tunnel of the RPR ring network according to an embodiment of the present invention. In the example embodiment, the addresses in the packets are Media Control Access (MAC) addresses, although it should be understood that other types of address may be used. Alongside the flow diagrams are packet diagrams 505a-i with overhead and payload portions. The packet diagrams 505a-i are located horizontally from their corresponding flow diagram components. Referring first to FIG. 5A, an RPR station switch block 510 receives traffic 505a from a port and determines to what port to forward the traffic 505a by searching a forwarding table based on a destination address (511). The switch block 510 then determines whether the port to which the traffic 505a is to be forwarded is a tunnel port (512). If not, the traffic 505b is forwarded to the determined port without modification (513); however, if the determined port is a tunnel port, then a tunnel overhead label 506 indicating on which tunnel the traffic is to be forwarded is added to the traffic 505c (514).

The modified traffic 505d is then sent to the RPR block 520 (515) and received (517) as a tunnel frame, as illustrated in FIG. 5B. The RPR block 520 determines whether the traffic 505e is tunnel traffic by examining the traffic for a tunnel overhead (521 and 522). If the traffic 505e is not tunnel traffic (522), the traffic 505e is handled as unknown traffic 505f per IEEE 802.17 (523); however, if the traffic 505e is tunnel traffic (522), then a destination RPR MAC address is determined from a mapping table based on the tunnel indicated in the tunnel overhead (524), and the traffic 505e is handled as known traffic 505g per IEEE 802.17 (525). The traffic 505h or 505i is then added to the RPR ring (526).

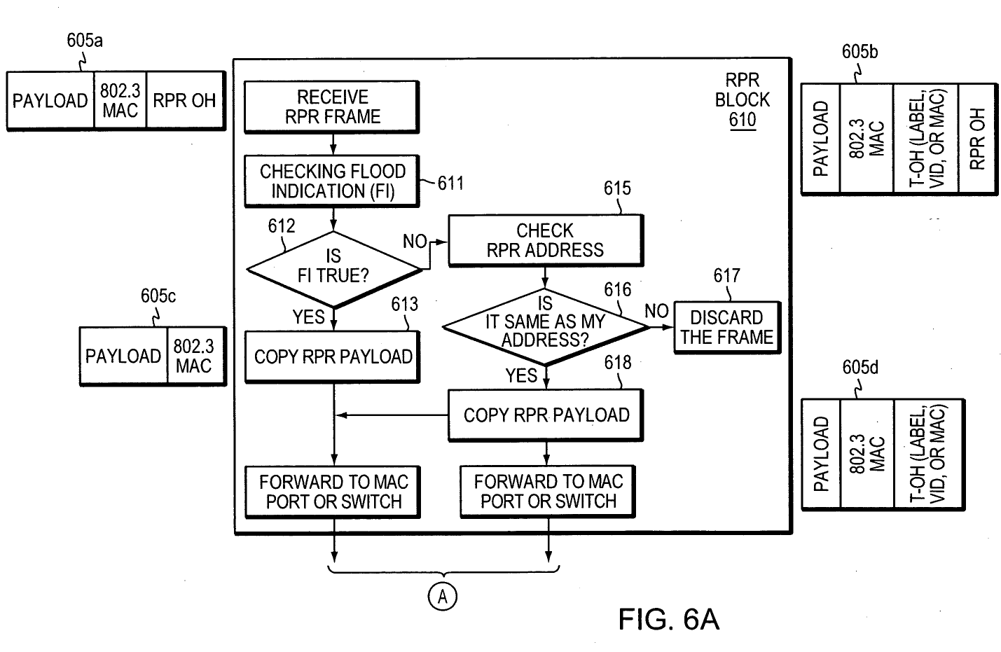

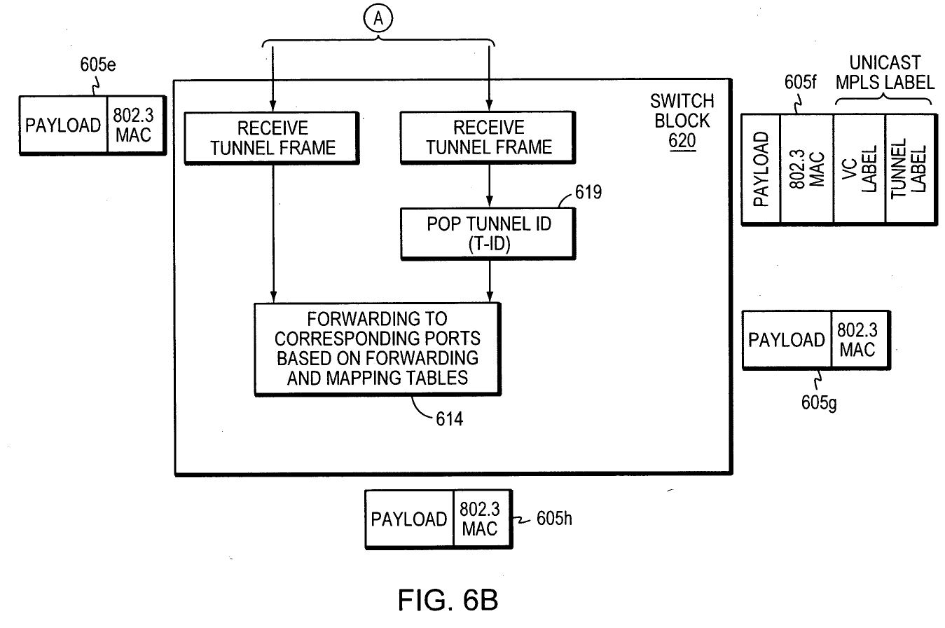

FIGS. 6A and 6B are flow diagrams illustrating handling network traffic received at an RPR station in an RPR ring network according to an embodiment of the present invention. In the example embodiment, the addresses in the packets are MAC addresses, although it should be understood that other types of address may be used. Alongside the flow diagrams are packet diagrams 605a-h with overhead and payload portions. The packet diagrams 605a-h are located horizontally from their corresponding flow diagram components. Referring first to FIG. 6A, upon receiving an RPR frame 605a or 605b, an RPR block 610 determines whether flooding has been enabled for the traffic (611 and 612). If flooding has been enabled (612), then the traffic 605c is copied (613) and the traffic 605e, 605h is forwarded to a corresponding port based on a forwarding table (614); however, if flooding has not been enabled (612), the RPR block 610 determines whether the RPR address is the same as the address of the station (615 and 616). If it is not the same (616), then the frame is discarded (617); however, if the addresses match (616), then the traffic 605d is copied (618), the tunnel overhead of the traffic 605g is removed (619), and the underlying traffic 605h is forwarded to a port based on the forwarding table (614).

While this invention has been particularly shown and described with references to example embodiments thereof, it will be understood by those skilled in the art that various changes in form and details may be made therein without departing from the scope of the invention encompassed by the appended claims.

It should be understood that the flow diagrams of FIGS. 5A, 5B, 6A, and 6B are examples that can include more or fewer components, be partitioned into subunits, or be implemented in different combinations. Moreover, the flow diagrams may be implemented in hardware, firmware, or software. If implemented in software, the software may be written in any software language suitable for use in networks and switches as illustrated in FIGS. 1, 2A-2D, 3, 4A, and 4B. The software may be embodied on any form of computer readable medium, such as RAM, ROM, or magnetic or optical disk, and loaded and executed by generic or custom processor(s).

The invention is applicable to any network topology as long as a ring network, such as a Synchronous Optical Network (SONET) ring network or a Dense Wavelength Division Multiplexing (DWDM) ring, is established.

What is claimed is:

1. A station in a ring network, comprising:
a comparison module to compare a destination address in a packet traffic signal with known addresses corresponding to identifiers of tunnels in the ring network, the identifiers of the tunnels previously associated with the known addresses;
an association module to associate an identifier of a tunnel in the ring network with the packet traffic signal based on a comparison made by the comparison module and to associate with the packet traffic signal an identifier of a destination station in the ring network corresponding to the identifier of the tunnel; and
a forwarding module to forward the packet traffic signal to the destination station via the tunnel.

2. The station of claim 1 wherein the destination address in the packet traffic signal and the known addresses are media access control (MAC) addresses.

3. The station of claim 1 wherein the destination address in the packet traffic signal is unknown to the comparison module.

4. The station of claim 1 wherein the comparison module includes logic to learn a correspondence between unknown addresses and the identifiers of tunnels using standard learning techniques.

5. The station of claim 1 wherein the identifier of the destination station is a resilient packet ring (RPR) MAC address.

6. The station of claim 1 wherein the association module includes a table having a correspondence between the identifiers of tunnels and identifiers of other stations in the ring network, and wherein the association module includes logic to determine the identifier of the destination station from the table based on the identifier of the tunnel.

7. The station of claim 1 wherein the comparison module includes a table having a correspondence between the known addresses and the identifiers of tunnels, and wherein the comparison module includes logic to determine an identifier of a tunnel from the table based on the destination address.

8. The station of claim 1 wherein the association module includes logic to add the identifier of the tunnel and the identifier of the destination station to the packet traffic signal.

9. A method of switching packet traffic in a ring network, comprising:
comparing a destination address in a packet traffic signal with known addresses corresponding to identifiers of tunnels in the ring network, the identifiers of the tunnels previously associated with the known addresses;
associating an identifier of a tunnel in the ring network with the packet traffic signal based on the comparison;
associating with the packet traffic signal an identifier of a destination station in the ring network corresponding to the identifier of the tunnel; and
forwarding the packet traffic signal to the destination station via the tunnel.

10. The method of claim 9 wherein the destination address in the packet traffic signal and the known addresses are media access control (MAC) addresses.

11. The method of claim 9 wherein the destination address in the packet traffic signal is an unknown address.

12. The method of claim 9 further including learning a correspondence between unknown addresses and the identifiers of tunnels using standard learning techniques.

13. The method of claim 9 wherein the identifier of the destination station is a resilient packet ring (RPR) MAC address.

14. The method of claim 9 further including provisioning a table providing a correspondence between the identifiers of tunnels and identifiers of stations in the ring network, and wherein associating the identifier of the destination station includes determining the identifier of the destination station from the table based on the identifier of the tunnel.

15. The method of claim 9 wherein comparing the destination address with the known addresses includes determining an identifier of a tunnel from a table based on the destination address, the table having a correspondence between the known addresses and the identifiers of tunnels.

16. The method of claim 9 wherein associating the identifier of the tunnel with the packet traffic signal includes adding the identifier of the tunnel to the packet traffic signal, and associating the identifier of the destination station with the packet traffic signal includes adding the identifier of the destination station to the packet traffic signal.

17. A station in a ring network, comprising:
a learning module to learn a correspondence between addresses and identifiers of tunnels in the ring network; and
an association module to associate an identifier of a tunnel in the ring network with an identifier of another station in the ring network from a table having a correspondence between the identifiers of tunnels and identifiers of other stations in the ring network.

18. The station of claim 17 wherein the identifiers of other stations are resilient packet ring (RPR) MAC addresses.

19. The station of claim 17 wherein the table is a provisioned table.

20. The station of claim 17 further including logic to update the table through signaling.

21. The station of claim 17 wherein the learning module includes logic to compare a destination address in a packet traffic signal with the addresses, wherein the association module includes logic to associate an identifier of a tunnel in the ring network with the packet traffic signal based on a comparison made by the learning module, and includes logic to associate an identifier of a destination station in the ring network with the packet traffic signal from the table based on the identifier of the tunnel, and further including a forwarding module to forward the packet traffic signal to the destination station via the tunnel.

22. The station of claim 21 wherein the destination address in the packet traffic signal is unknown to the learning module.

23. The station of claim 21 wherein the learning module includes a forwarding table having a correspondence between the addresses and the identifiers of tunnels, and further includes logic to determine an identifier of a tunnel from the forwarding table based on the destination address in the packet traffic signal.

24. The station of claim 21 wherein the association module includes logic to add the identifier of the tunnel and the identifier of the destination station to the packet traffic signal.

25. A method of switching packet traffic in a ring network, comprising:
learning a correspondence between addresses and identifiers of tunnels in the ring network; and
associating an identifier of a tunnel in the ring network with an identifier of a station in the ring network from a table having a correspondence between the identifiers of tunnels and identifiers of stations in the ring network.

26. The method of claim 25 wherein the identifiers of stations are resilient packet ring (RPR) MAC addresses.

27. The method of claim 25 further including provisioning the table.

28. The method of claim 25 further including updating the table through signaling.

29. The method of claim 25 further including:
comparing a destination address in a packet traffic signal with the addresses;
associating an identifier of a tunnel in the ring network with the packet traffic signal based on the comparison;
associating an identifier of a destination station in the ring network with the packet traffic signal from the table based on the identifier of the tunnel; and
forwarding the packet traffic signal to the destination station via the tunnel.

30. The method of claim 29 wherein the destination address in the packet traffic signal is an unknown address.

31. The method of claim 29 wherein comparing the destination address with the addresses includes determining an identifier of a tunnel from a forwarding table based on the destination address.

32. The method of claim 29 wherein associating the identifier of the tunnel with the packet traffic signal includes adding the identifier of the tunnel to the packet traffic signal, and associating the identifier of the destination station with the packet traffic signal includes adding the identifier of the destination station to the packet traffic signal.

33. A station in a ring network, comprising:
a table having a correspondence between identifiers of tunnels in the ring network and identifiers of other stations in the ring network.

34. The station of claim 33 wherein the identifiers of the other stations are resilient packet ring (RPR) MAC addresses.

35. The station of claim 33 further including a module to update the table through signaling.

36. The station of claim 33 further including multiple logical ports associated with a ring port.

37. The station of claim 36 wherein the identifiers of tunnels correspond to the multiple logical ports.
